(19) United States
(12) Patent Application Publication
(10) Pub. No.: US 2009/0204615 A1
(43) Pub. Date: Aug. 13, 2009

(54) PERSISTENT CROSS PLATFORM COLLECTION OF AUDIENCE DATA

(76) Inventors: Eduardo G. Samame, Rowayton, CT (US); William Eric Kreth, Long Island City, NY (US); Forrest M. Murphy, Clayton, MO (US)

Correspondence Address: The Marbury Law Group, PLLC, 11800 SUNRISE VALLEY DRIVE, SUITE 1000, RESTON, VA, 20191, US

(21) Appl. No.: 12/027,698

(22) Filed: Feb. 7, 2008

(51) Int. Cl. G06F 17/30

(52) U.S. Cl. 707/9; 707/E17.059

(57) ABSTRACT

Previous attempts to measure content and/or advertising consumption treat each category as a unique silo of information. A method, system, and method of doing business generate a profile by obtaining at least a first and second data measurement from a user impression of a linear source of content and a user impression of a time-shifted source of content and/or a user impression of an interactive source of content, and associating the measurements with a user ID to generate a profile.

### FIELD OF THE INVENTION

The invention relates to a system for collecting data on the content consumption of individuals where the content comes from multiple sources, i.e., television, video-on-demand, and internet and subsequent methods to utilize and monetize such data.

### BACKGROUND AND SUMMARY OF THE INVENTION

It is important for content providers (i.e., television programming), service providers (internet, cable, fiber, etc.), marketers, and those who sell advertising to know the effectiveness of their content or advertisements to properly establish value and measure effectiveness. Currently, advertising agencies and content programmers receive information from commercial rating sources (i.e., Nielsen Media Research). This can be information about a particular source of content, such as linear broadcast usage (i.e., television, radio), interactive service usage (i.e., internet usage, interactive cable offerings), or time-shifted content usage (i.e., on-demand services, digital video recorder usage).

Previous attempts to measure content and/or advertising consumption treat each category as a unique silo of information. For example, a particular company will measure data regarding number of homes watching a particular linear broadcast at a particular time by placing devices in a limited population of homes and extrapolating overall viewership in a particular region. The company will sell this information to advertisers, programmers, and system operators (end users) who use it in pricing their content and services. This information does not take into account additional sources of content consumption and therefore offers a limited perspective of a content consumers' activity. This limited perspective has lesser value to those seeking to establish a return on their content and advertising expenditures. Additionally, multiple service operators (MSOs) offer various sources to their subscribers all under common control (for example, discrete web consumption data is given to a net ratings company, TV consumption is derived by TV rating companies and time shifted/VOD is done by others). What is needed is a way to combine measurements of content consumption from various sources and provide them in an integrated manner to provide a clear overall picture of content and/or advertising consumption.

The invention includes a method, system, and method of doing business to satisfy the aforementioned need. In one aspect, a method of generating a profile includes: obtaining a first data measurement from a user impression of a linear source of content; obtaining a second measurement from a user impression of a time-shifted source of content; obtaining a third measurement from a user impression of an interactive source of content; and associating the first, second, and third measurements with a user ID to generate a profile.

In one embodiment, the method includes comparing the generated profile to an existing profile, determining whether the generated profile contains an update to the existing profile, and updating the existing profile upon determination of an update. The linear source, the time-shifted source, and the interactive source are all under common control of a service provider. In another embodiment, the time-shifted source of content can be a video-on-demand source, the interactive source of content can be a data source, and the linear source of content further can be a broadcast source.

In one embodiment, the method further includes compiling more than one profile from said first, second, and third measurements. In another embodiment, the data source can be an internet data source.

In one embodiment, the method includes normalizing one of the first, second, and third measurements. In another embodiment, the method includes collecting more than one of said profiles having a common link and generating a cohort which represents said collection of more than one of said profiles.

In one aspect, a method of generating a profile includes obtaining a first data measurement from a user impression of a linear source of content; obtaining a second measurement from at least one of: a user impression of a time-shifted source of content and a user impression of an interactive source of content; and associating the first and second measurements with a user ID to generate a profile.

In another aspect, a system for generating a profile includes a linear source of content, a time-shifted source of content, an interactive source of content, a content transmission network for transmitting content from said linear, interactive, and time-shifted sources of content to at least one user device, the at least one user device includes a processor for receiving said transmitted content and generating a signal for display on a display device, at least one device for rendering said transmitted content appreciable to at least one human sense, a user-operable control device for controlling the at least one user device and sending information over the content transmission network. The content transmission network includes at least one measurement device for measuring data regarding said first, second, and third sources from said user-operable control device, said user device, and/or said content, a memory, a local cache, a database, and a processor for associating the measured data to a user ID to generate the profile.

In one embodiment, the linear source, the time-shifted source, and the interactive source are all under common control of a service provider. In another embodiment, the time-shifted source of user-interactive content includes a video-on-demand source; the interactive source of user-interactive content includes a data source; and the linear source of content includes a broadcast source.

In one embodiment, the content transmission network includes a hybrid fiber coax network, a fiber optic network, an Ethernet network, a wireless network, or an internet protocol network.

In one embodiment, the at least one user device is a set-top box, a cable modem, a microcomputer, a television, a gaming console, or a mobile phone. In another embodiment, the user-operable control is a keyboard, a remote control, a mouse, a touch screen or a joystick. In one embodiment, a memory stores the profile. In another embodiment, the memory stores more than one profile. In another embodiment, the memory stores more than one profile from more than one user device.

In one embodiment, the measurement device measures at least one of the following explicit or derived events: time spent viewing, duration of asset, content metadata, source identity, dwell time, stream identity, number of clicks of said user-operable control device, frequency of clicks of said user-operable control device, information entered on said user-operable control device, number of sessions, bandwidth utilization, channel number, tuning events, page views, point-of-sale transactions, television viewing data, video-on-demand orders, interactive advertisement interactions, metadata regarding an asset, asset identification, source identification, stream identity, interactive program guide information, contemporaneous multi-source content consumption, phone usage, IP address, MAC address, interactions, user input, commercial transaction data, connected devices ID, displayed applications or overlays, and user identification.

In one embodiment, the interactive source of content contains a user-interactive component.

In one embodiment, the content transmission network includes a mediation unit that normalizes measurements received by the at least one measurement device; and a profiling engine that collects more than one of said profiles to generate a cohort. In another embodiment, the profile engine compares the profiles to generate said cohort.

In one embodiment, the mediation unit includes a local cache, memory, a processor, and means for receiving data from the measurement device.

In one embodiment, the processor of the mediation unit receives the data, identifies whether it represents a new profile, and the processor directs the memory of the mediation unit to store substantially all of said data for a new profile and less than all of said data for a non-new profile. In another embodiment, the mediation unit sends data to an external memory store. In another embodiment, the cohort is available over a web interface from a server coupled to the profiling engine.

In one aspect, a method of generating revenue includes obtaining a first data measurement from a user impression of a linear source of user-interactive content, obtaining a second measurement from a user impression of a time-shifted source of user-interactive content, obtaining a third measurement from a user impression of an interactive source of content, generating at least two profiles by comparing said first second and third measurements to at least one stored value in a database, generating a cohort from said at least two profiles, dynamically adjusting the pricing of said cohort depending upon a property of the first, second, and/or third measurements.

The advantages of the invention will be evident from the description, figures, and claims which follow.

### BRIEF DESCRIPTION OF THE DRAWINGS

FIG. 1 is a functional block diagram illustrating an exemplary HFC cable network configuration useful with the present invention.

FIG. 1a is a functional block diagram illustrating one exemplary HFC cable network headend configuration useful with the present invention.

FIG. 1b is a functional block diagram illustrating one exemplary local service node configuration useful with the present invention.

FIG. 1c is a functional block diagram illustrating one exemplary broadcast switched architecture (BSA) network useful with the present invention.

FIG. 2 is a block diagram illustrating a typical prior art premises network topology used with a cable television network.

FIG. 3 illustrates a profile generator;

FIG. 4 illustrates a flow diagram representing a method for generating a profile.

### DETAILED DESCRIPTION OF THE INVENTION

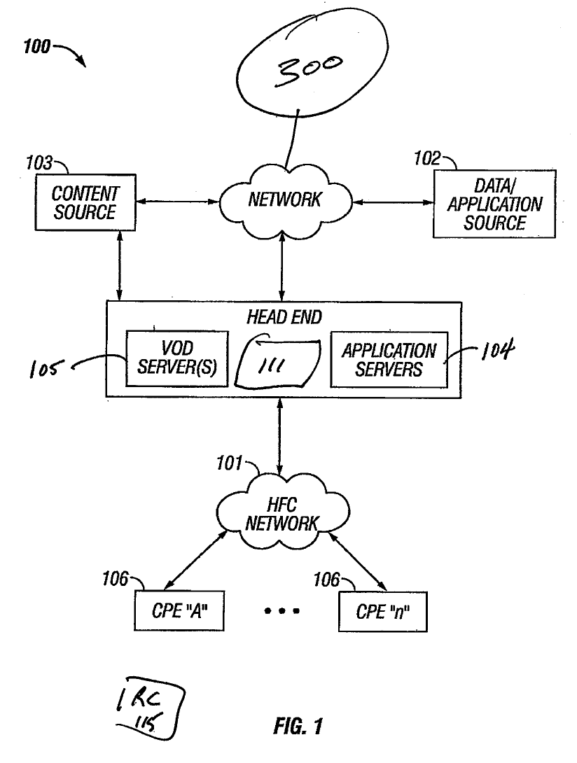

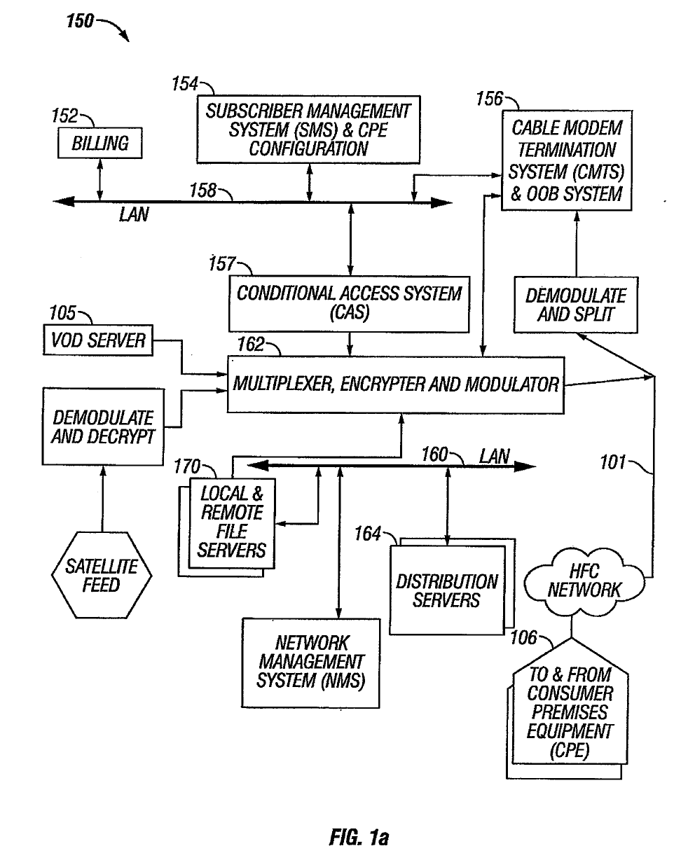

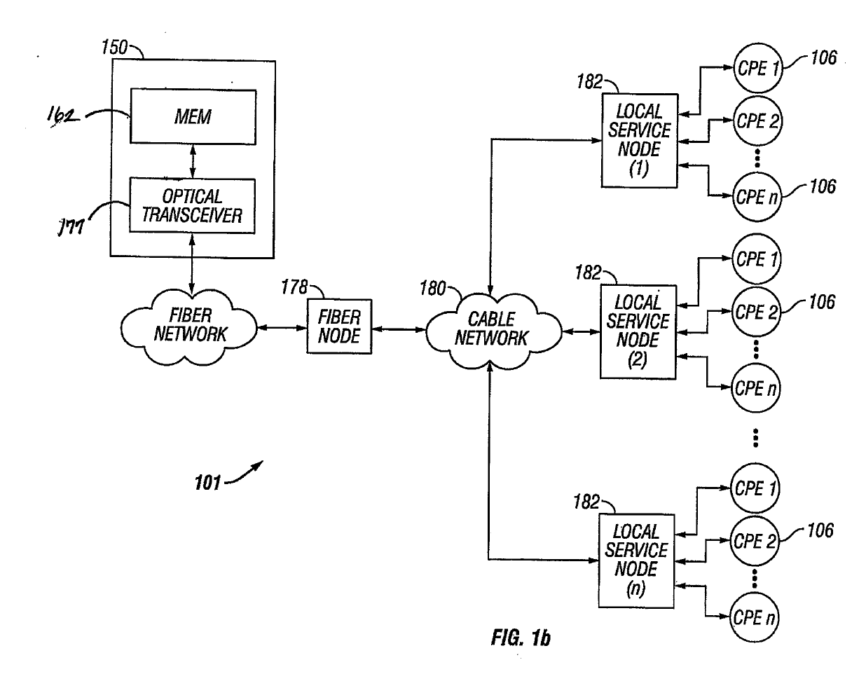

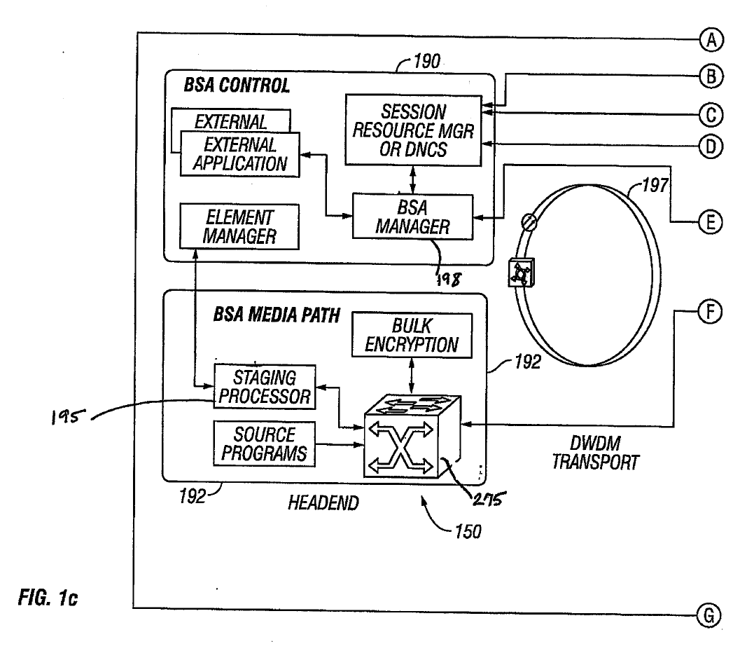

FIG. 1 illustrates a typical content-based network configuration with which the apparatus and methods of the present invention may be used. The various components of the network 100 include (i) one or more data and application origination points 102; (ii) one or more content sources 103, a head end containing (iii) one or more application distribution servers 104; (iv) one or more video on demand (VOD) servers 105, and at the terminus of the bearer network 101, (v) customer premises equipment (CPE) 106. The distribution server(s) 104, VOD servers 105 and CPE(s) 106 are connected via the bearer (e.g., HFC) network 101. Content sources 103 can include, for example, linear broadcast video and/or audio, time shifted VOD, or digitally recorded content on CPE 106. A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the invention. For example, the headend architecture of FIG. 1a (described in greater detail below) may be used.

The data/application origination point 102 comprises any medium that allows data and/or applications (such as a VOD-based or “Watch TV” application) to be transferred to a distribution server 104. This can include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers' premises” (or other locations, whether local or remote to the distribution server 104) that can be accessed by an application server 104. CPE 106 can also include devices connected (i.e., wired or wireless) that access HFC network 101 via CPE 106. CPE 106 can be connected to at least one device (i.e., a television, an audio player, etc.) which renders transmitted content appreciable to at least one human sense. Additionally, CPE 106 can be integrated into a device that renders transmitted content appreciable to at least one human sense.

Referring now to FIG. 1a, one exemplary embodiment of a headend architecture useful with the present invention is described. As shown in FIG. 1a, the headend architecture 150 comprises typical headend components and services including billing module 152, subscriber management system (SMS) and CPE configuration management module 154, cable-modem termination system (CMTS) and out of band (OOB) system 156, as well as LAN(s) 158, 160 placing the various components in data communication with one another. It will be appreciated by those skilled in the art that while a bar or bus LAN topology is illustrated, any number of other arrangements as previously referenced (e.g., ring, star, etc.) may be used consistent with the invention. Alternatively OOB system 156 can be an in-band in-mux system whereby data delivery includes transmitting data streams on at least a portion of a forward QAM channel. It will also be appreciated by those skilled in the art that the headend configuration depicted in FIG. 1a is high-level, conceptual architecture and that each MSO may have multiple headends deployed using custom architectures.

The architecture 150 of FIG. 1a further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend and sent to neighborhood hubs via a variety of interposed network components.

Content (e.g., audio, video, data, files, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0, 2.0, 3.0 (and subsequent) specification provides for exemplary networking protocols both downstream and upstream, although the invention is in no way limited to these approaches.

It will also be recognized that the multiple servers (broadcast, VOD, or otherwise) can be used and disposed at two or more different locations if desired, such as being part of different server “farms.” These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different locations are used to feed one or more service groups.

### “Switched” Networks

FIG. 1c illustrates an exemplary “switched” network architecture also useful with the features of the present invention. While a so-called “broadcast switched architecture” or BSA network is illustrated in this exemplary embodiment, it will be recognized that the present invention is in no way limited to such architectures.

Switching architectures allow improved efficiency of bandwidth use for ordinary digital broadcast programs. Ideally, the subscriber will be unaware of any difference between programs delivered using a switched network and ordinary streaming broadcast delivery.

FIG. 1c shows the implementation details of one exemplary embodiment of this broadcast switched network architecture. Specifically, the headend 150 contains switched broadcast control and media path functions 190, 192; these elements cooperate to control and feed, respectively, downstream or edge switching devices 194 at the hub site which are used to selectively switch broadcast streams to various service groups. A particular CPE 106 receives a session including switched channels sent from BSA server 196 upon a user's request or CPE tuning. BSA server 196 is also disposed at the hub site, and implements functions related to switching and bandwidth conservation (in conjunction with a management entity 198 disposed at the headend). An optical transport ring 197 is utilized to distribute the dense wave-division multiplexed (DWDM) optical signals to each hub in an efficient fashion. Co-owned and co-pending U.S. patent application Ser. No. 09/956,688 filed Sep. 20, 2001 and entitled “TECHNIQUE FOR EFFECTIVELY PROVIDING PROGRAM MATERIAL IN A CABLE TELEVISION SYSTEM”, incorporated herein by reference in its entirety, describes one exemplary broadcast switched digital architecture useful with the present invention, although it will be recognized by those of ordinary skill that other approaches and architectures may be substituted.

In addition to “broadcast” content (e.g., video programming), the systems of FIGS. 1a and 1c also deliver internet data services using the Internet Protocol (IP), although other protocols and transport mechanisms of the type well known in the digital communication art may be substituted. One exemplary delivery paradigm comprises delivering MPEG-based video content, with the video transported to user PCs (or IP-based STBs) over the aforementioned DOCSIS channels comprising MPEG (or other video codec such as H.264 or AVC) over IP over MPEG. That is, the higher layer MPEG or other encoded content is encapsulated using an IP protocol, which then utilizes an MPEG packetization of the type well known in the art for delivery over the RF channels. In this fashion, a parallel delivery mode to the normal broadcast delivery exists; i.e., delivery of video content both over traditional downstream QAMs to the tuner of the user's STB or other receiver device for viewing on the television, and also as packetized IP data over the DOCSIS QAMs to the user's PC or other IP-enabled device via the user's cable modem.

Referring again to FIG. 1c, the IP packets associated with internet services and containing internet content are received by edge switch 194 from any source of internet- or client-based data, and forwarded to the cable modem termination system (CMTS) 199. The CMTS examines the packets and forwards packets intended for the local network to the edge switch 194. Other packets are discarded or routed to another component.

The edge switch 194 forwards the packets received from the CMTS 199 to the QAM modulator 189, which transmits the packets on one or more physical (QAM-modulated RF) channels to the CPE. The IP packets are typically transmitted on RF channels that are different than the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve.

### Premises and Network

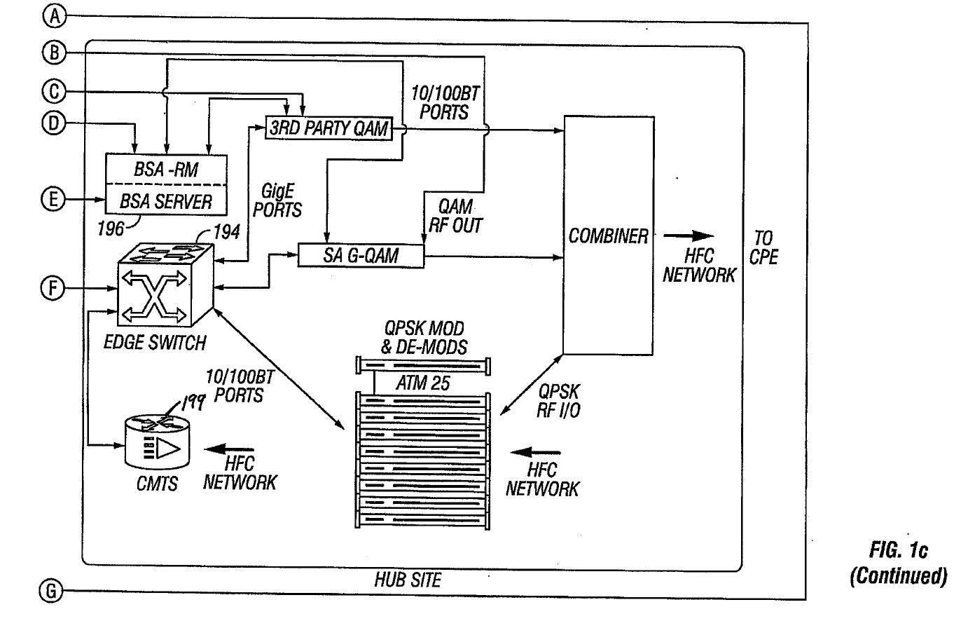

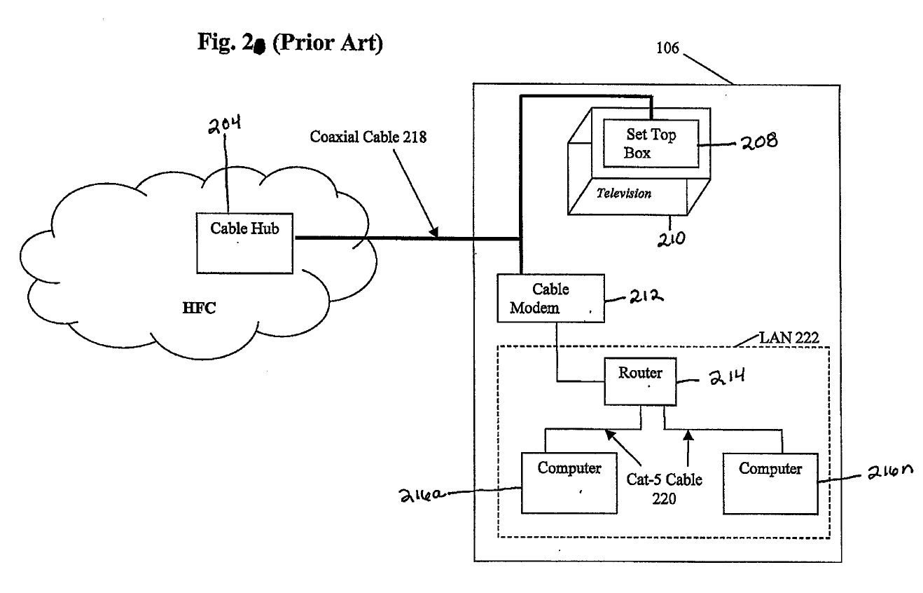

FIG. 2a illustrates a common prior art premises network topology. The cable headend 150 (FIG. 1a) communicates with the customer premises equipment (CPE) 106 by means of an intermediary HFC network 101 and hub 204. The “last mile” connection to the customer's premises is typically via coaxial cable 218, but in some instances, fiber optic cable replaces coaxial cable as in a fiber-to-the-home (FTTH) implementation. So-called “fiber-to-the-curb” or FTTC optical implementations may also be used.

The terminating coaxial cable 218 is routed into the customer premises 106, and is connected to one or more set-top boxes 206 (e.g., DSTB) and/or one or more cable modems 212 (e.g., DOCSIS modem). Typically, program channel content is transmitted downstream from the cable headend 150 or a BSA switching node over in-band frequencies, and internet (e.g., Internet) content is transmitted from the cable modem termination system (CMTS) over DOCSIS frequencies.

A set-top box 206 receives analog (or digital) signals from the network via the coaxial cable, then processes the input signals appropriately (i.e., demodulate, decode) to be compatible with a display device (e.g., television 210) or other apparatus. These signals may also be distributed via, for example, a back-end interface to DVRs, personal media devices (PMDs), and the like.

The cable modem 212 operates in a generally similar fashion. The cable modem 212 receives analog signals from the network, demodulates the analog signals, converts the demodulated signals into digital signals, and transmits the digital signals to a computerized device (e.g., personal computer 216) or series of computers 216a to 216n in a premises local area network (LAN) 222.

As illustrated by FIG. 2a, customer premises equipment (CPE) typically comprises the cable modem 212 and the set-top box 208 which are separate physical units. Multiple units typically require more physical space, as well as more wiring, in the customer's premises than a single, integrated device. For example, separate coaxial cable drops may be required for in-band and DOCSIS delivery, as are separate power cords and back-end interfaces. Additionally, the manufacture of separate set-top boxes and cable modems is more expensive than the manufacture of a single device incorporating the functionalities of both units. Compatibility issues (whether at a hardware or software level) may arise if the devices are placed in communication with one another; these issues are effectively obviated when a unified device is used, since the device hardware and software (including middleware) necessary to support the various functions are developed commonly, and utilize a common operating system.

Referring again to FIG. 1, headend 101 contains a measuring device 111 which measures data regarding content passing both from content source 103 to CPE 106 and from CPE 106 back through network 101 over, for example, a reverse data channel. The data from content source 103 to CPE 106 can be, for example, metadata regarding an asset, asset identification, source identification, stream identity, interactive program guide information, contemporaneous multi-source content consumption (e.g., mosaic display), data from multiple CPEs within a single physical domain (e.g., a house, dorm, barracks, or multiple-dwelling unit building) or phone usage (e.g., caller ID information).

The data measured from CPE 106 back through network 101 can be, for example, time spent on a particular channel, duration of an asset, stored content metadata, source identity, dwell time, stream identity, clicks of a user-operable control device 115 (i.e., remote control), number or frequency of clicks of user-operable control device 115, information entered on user-operable control device 115, number of sessions, bandwidth utilization, channel number, tuning events, page views, point-of-sale transactions, television viewing data, video-on-demand orders, interactive advertisement interactions, IP address, interactions (e.g., though IPG overlay), user input (e.g., interactive advertising responses), telephone usage (e.g., dialed numbers), commercial transaction data, connected devices ID (e.g., accessing internet through mobile phone over WiFi in STB), displayed applications or overlays, or user identification (e.g., characteristics of a particular user or household).

Measuring device 111 measures data from at least two sources of content. This can be any combination of: linear content, time-shifted content, and interactive content. Linear content can be broadcast television, radio, or any other content that does not have the ability to be time-shifted or interactive. Time-shifted content can be VOD or any other content stored on hardware or software in the home or on a network for subsequent consumption. Interactive content can be content consumed from the internet, broadcast content with interactive features (i.e., interactive advertising, polling, etc.), or any other form of content where the consumer of the content passes information back over network 101. Interactive content can also be wireless communication or telephone communication (i.e., voice over IP (VOIP) data). Measuning device 111 can be a single device situated at the headend as shown in FIG. 1, or it can be a series of distributed devices within the network 100 or CPE devices 106 that all report measurements to a common location.

Statistics can be measured from a switched architecture by querying a BSA server as to what channels are added or subtracted, which users request switched channels, which channels are being viewed at a particular time, which channels are viewed in particular geographic regions, etc. Inferential algorithmic analysis of switching can provide this statistical information, for example, channel consumption, etc. Switched could be linear or interactive depending on the channel switched.

Measuring device 111 performs measurements by querying CPE 106 for information regarding user impressions (or CPE events), passively receiving information from CPE 106 regarding user impressions, querying or receiving information from VOD server 105, querying or receiving information from application server 104, querying or receiving information from edge switch 194, or querying or receiving information from any other source with the ability to provide user impression data. This data will include a user ID field that links the user to the impression. It will also include a source field to identify the source of the content (i.e., linear, interactive, time-shifted, etc.). Additional fields can include information about the impression itself.

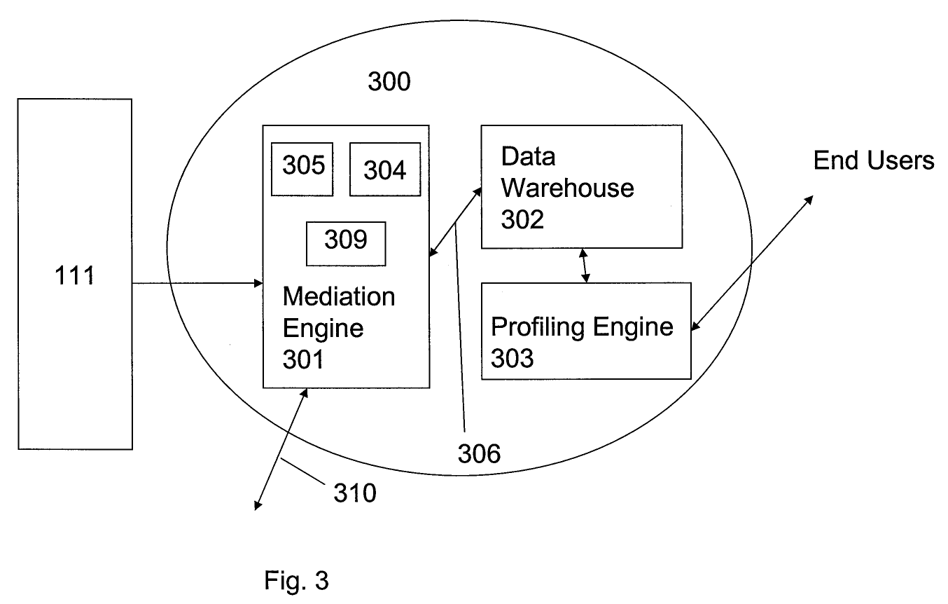

The data which measuring device 111 measures passes to a profile generator 300 as depicted in FIG. 3. At least two sources of data (i.e., linear, time-shifted, and interactive) pass to profile generator 300 from measuring device 111, for example, over a network. Within profile generator 300 are a mediation component 301, a data warehouse 302, and a profiling engine 303. There may be multiple data warehouses 302; for example, where each source of data is stored separately. Mediation component 301 includes a processor 304, a memory 305, and an interface 306. Processor 304 receives the data output of measuring device 111. It detects the user ID and source field. Processor 304 can then mediate the data and compress it, filter out any personally identifiable information or non-valuable data (e.g., as parameterized by a service operator), and search for existing profiles in either memory 305 or data warehouse 302 that may require updating based on the incoming measurements. Impressions data is then stored in memory 305, which can be temporary memory such as a buffer. Additionally, mediation component 301 can enrich measurement data. This can be done through an interface 310 to a third party source of data or by internally enriching the data using a data enrichment engine 309. Data enrichment augments the data generated from measurement device 111 from a secondary source of data. This augmentation could be, for example, electronic program guide information, demographic data, geographic data, or any other kind of data which enriches the measurement data in a useful way.

Upon determining that incoming measurement data pertains to an existing profile, processor 304 looks at the profile data of the identified user and determines if any field from measuring device 111 requires updating the profile stored in memory. If so, processor 304 can direct the interface 306 to transmit the data to data warehouse 302. In order to maximize storage space, processor 304 can direct interface 306 to transmit a subset of the data (i.e., any new data). If no existing profile is associated with the user ID, processor 304 creates a new profile and directs interface 306 to transmit it to data warehouse 302. A profile contains at least two or three sources of data (i.e., linear, time-shifted, and interactive) each of which is independently updatable.

Profiling engine 303 compiles profiles from data warehouse 302 to generate cohorts. A cohort is a representation of a group of profiles with some common link between them. For example, a group of users who consume sports content, specifically baseball viewers who watch more than one game per week. Profiling engine 303 can also provide raw profile data.

An end user of profiles and cohorts pays for this information for use in pricing their content and services as well as to direct targeted advertising to subscribers or to power any decision support system. A decision support system can be, for example, linear or time shifted advertisement insertion, online advertising insertion, commerce engines, bid/auction systems, content profiling, recommendation engines. Since the profiles and cohorts are comprehensive (i.e., include information regarding at least two sources of content) they are exponentially more valuable than information regarding only one source of content. In essence, the profiles and cohorts provide a complete picture of nearly all content consumption by a particular subscriber or subset of subscribers. An MSO controlling these sources of content has easy access to all the data and can compile profiles and cohorts with relative ease.

A seller of profile or cohort data can charge various prices depending on the class or granularity of data they provide. For example, a cohort generated from a small sampling of subscribers may be sold for less than a cohort generated from a large sampling of subscribers. Additionally, a cohort compiled from many impression fields can be sold for more than a cohort compiled from a few. The profile or cohort generating entity can set up a variable pricing arrangement whereby consumers of cohort or profile information can pay according to the granularity of the data. The profiling engine may make profile or cohort data accessible over the internet or via some other network. This will enable interested parties to view and purchase profile or cohort data remotely. The profile or cohort generating entity can also choose to sell the data by auction or any other known means of setting a price; for example, by accessing a advertising exchange.

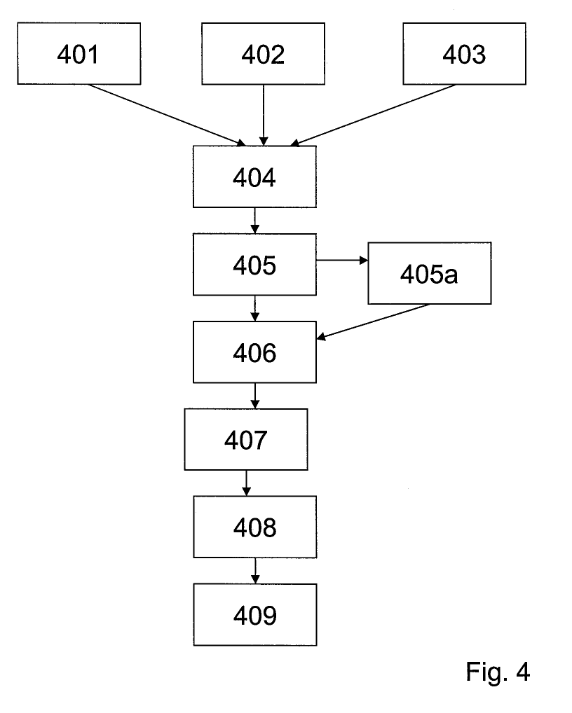

FIG. 4 illustrates a flow diagram representing the steps involved in generating and selling profiles and cohorts according to the invention. In step 401 measurement device 111 measures a first measurement from a user impression of a linear source of content. In step 402 measurement device 111 measures a second measurement from a user impression of a time-shifted source of content. In step 403 measurement device 111 measures a third measurement from a user impression of an interactive source of content. In step 404 measurement device 111 transmits the first, second, and third measurements to profile generator 300. In step 405 mediation engine 301 receives the first, second, and third measurements and generates a profile. This can be done, for example, by interpreting a user ID field that links the user to the impression, a source field to identify the source of the content (i.e., linear, interactive, time-shifted, etc.), and additional fields which include information about the impression itself. Additionally, data in the aforementioned fields can be manipulated to strip out or encrypt personally identifiable information (i.e., user ID, etc.) or to limit or reduce the amount of the data to be interpreted to particular kinds of impression information based, for example, on summarization rules.

Optionally, in step 405a, measurement data received in step 405 can be enriched. In step 405a, the mediation engine enriches the collected measurement data through secondary data sources.

In step 406, the mediation engine 301 compares the profile generated in step 405 to existing profiles in, for example, memory 305 or data warehouse 302. This comparison searches for existing profiles with the same user ID and determines whether the generated profile contains updates to any field in an existing profile. If so, the information regarding the update is stored in step 407. New profiles, where no existing user ID is found, can be stored in their entirety in step 407. In step 408 profiling engine 303 generates a cohort from profile data in, for example, data warehouse 302. This can be achieved by retrieving more than one profile with some common link between them and offering that group as a representation of a larger class of subscribers. For example, the profiling engine will perform an association of similar profiles by an application that is created in response to a request for particular information. For example, the application can be programmed to associate viewers of television network ESPN with viewers who will also be likely to watch Cartoon network. In step 409, end users of profile or cohort data access profile generator 300 to acquire data; for example, over the Internet,. Input from the end users may be solicited by profile generator 300 which can provide customized profile or cohort data depending on the level of granularity requested by end users. Profile generator 300 may dynamically adjust the pricing for profile or cohort data depending on how detailed or encompassing the data made available is.

It will be understood by those skilled in the art that the present invention may be, without limitation, embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the,” is not to be construed as limiting the element to the singular. Moreover, a reference to a specific time, time interval, and instantiation of scripts or code segments is in all respects illustrative and not limiting.

What is claimed is:

1. A method of generating a profile comprising:
obtaining a first data measurement from a user impression of a linear source of content;
obtaining a second measurement from a user impression of a time-shifted source of content;
obtaining a third measurement from a user impression of an interactive source of content; and
associating said first, second, and third measurements with a user ID to generate a profile.

2. The method of claim 1, wherein the method further comprises:
comparing the generated profile to an existing profile, determining whether the generated profile contains an update to the existing profile, and updating the existing profile upon determination of an update.

3. The method of claim 1, wherein the linear source, the time-shifted source, and the interactive source are all under common control of a service provider.

4. The method of claim 1, wherein the time-shifted source of content further comprises a video-on-demand source, the interactive source of content further comprises a data source, and the linear source of content further comprises a broadcast source.

5. The method of claim 1, wherein the method further comprises compiling more than one profile from said first, second, and third measurements.

6. The method of claim 4, wherein said data source further comprises an internet data source.

7. The method of claim 1, wherein the method further comprises:
normalizing one of the first, second, and third measurements.

8. The method of claim 1, wherein the method further comprises:
collecting more than one of said profiles having a common link; and
generating a cohort which represents said collection of more than one of said profiles.

9. The method of claim 1, wherein the first, second, and third measurements are augmented with enrichment data and the associating step further comprises associating the enrichment data with a user ID to generate the profile.

10. A method of generating a profile, comprising:
obtaining a first data measurement from a user impression of a linear source of content;
obtaining a second measurement from at least one of: a user impression of a time-shifted source of content and a user impression of an interactive source of content;
associating said first and second measurements with a user ID to generate a profile.

11. The method of claim 10, wherein the time-shifted source of content further comprises a video-on-demand source, the interactive source of content further comprises a data source, and the linear source of content further comprises a broadcast source.

12. The method of claim 10, wherein the method further comprises compiling more than one profile from said first, second, and third measurements.

13. The method of claim 11, wherein said data source further comprises an internet data source.

14. The method of claim 10, wherein the method further comprises:
normalizing one of the first, second, and third measurements.

15. The method of claim 10, wherein the method further comprises:
collecting more than one of said profiles having a common link;
generating a cohort which represents said collection of more than one of said profiles.

16. A system for generating a profile comprising:
a linear source of content;
a time-shifted source of content;
an interactive source of content;
a content transmission network for transmitting content from said linear, interactive, and time-shifted sources of content to at least one user device;
said at least one user device further comprising a processor for receiving said transmitted content and generating a signal for display on a display device;
at least one device for rendering said transmitted content appreciable to at least one human sense;
a user-operable control device for controlling said at least one user device and sending information over said content transmission network;
wherein said content transmission network further comprises:
at least one measurement device for measuring data regarding said first, second, and third sources from said user-operable control device, said user device, and/or said content;
a memory;
a database;
a processor for associating said measured data to a user ID to generate said profile.

17. The system of claim 16, wherein the linear source, the time-shifted source, and the interactive source are all under common control of a service provider.

18. The system of claim 16, wherein the time-shifted source of user-interactive content further comprises a video-on-demand source, the interactive source of user-interactive content further comprises a data source, and the linear source of content further comprises a broadcast source.

19. The system of claim 16, wherein said content transmission network further comprises a hybrid fiber coax network, a fiber optic network, an Ethernet network, a wireless network, or an Internet Protocol network.

20. The system of claim 16, wherein the at least one user device is a set-top box, a cable modem, a microcomputer, a television, a gaming console, or a mobile phone.

21. The system of claim 16, wherein said user-operable control further comprises a keyboard, a remote control, a mouse, or a joystick.

22. The system of claim 16, wherein said memory stores said profile.

23. The system of claim 22, wherein said memory stores more than one profile.

24. The system of claim 23, wherein said memory stores more than one profile from more than one user device.

25. The system of claim 16, wherein said measurement device measures at least one of time spent viewing, duration of asset, content metadata, source identity, dwell time, stream identity, number of clicks of said user-operable control device, frequency of clicks of said user-operable control device, information entered on said user-operable control device, number of sessions, bandwidth utilization, channel number, tuning events, page views, point-of-sale transactions, television viewing data, video-on-demand orders, interactive advertisement interactions, metadata regarding an asset, asset identification, source identification, stream identity, interactive program guide information, contemporaneous multi-source content consumption, phone usage, IP address, MAC address, interactions, user input, commercial transaction data, connected devices ID, displayed applications or overlays, and user identification.

26. The system of claim 16, wherein the interactive source of content contains a user-interactive component.

27. The system of claim 16, wherein the content transmission network further comprises:
A mediation unit; and
A profiling engine, wherein said mediation unit normalizes measurements received by the at least one measurement device, and wherein said profiling engine collects more than one of said profiles to generate a cohort.

28. The system of claim 27, wherein the profile engine compares the more than one of said profiles to generate said cohort.

29. The system of claim 27, wherein the mediation unit further comprises:
a memory;
a processor; and
means for receiving data from the measurement device.

30. The system of claim 29, wherein the processor of the mediation unit receives the data, identifies whether it represents a new profile, wherein said processor directs the memory of the mediation unit to store substantially all of said data for a new profile and less than all of said data for a non-new profile.

31. The system of claim 27, wherein the mediation unit sends data to an external memory store.

32. The system of claim 27, wherein said cohort is available over a web interface from a server coupled to the profiling engine.

33. A method of generating revenue comprising:
obtaining a first data measurement from a user impression of a linear source of user-interactive content;
obtaining a second measurement from a user impression of a time-shifted source of user-interactive content;
obtaining a third measurement from a user impression of an interactive source of content;
generating at least two profiles by comparing said first, second, and third measurements to at least one stored value in a database;
generating a cohort from said at least two profiles;
dynamically adjusting the pricing of said cohort depending upon a property of the first, second, and/or third measurements.
